(19) United States
(12) Patent Application Publication
(10) Pub. No.: US 2020/0269375 A1
(43) Pub. Date: Aug. 27, 2020

(54) Wood Splitting Turntable Assembly

(71) Applicants: Gerald Rowley, Vancouver, WA (US); Jeanne Rowley, Vancouver, WA (US)

(72) Inventors: Gerald Rowley, Vancouver, WA (US); Jeanne Rowley, Vancouver, WA (US)

(21) Appl. No.: 16/286,029

(22) Filed: Feb. 26, 2019

(51) Int. Cl. B23Q 7/02; B27L 7/06

(52) U.S. Cl. CPC B23Q 7/02; B23Q 2220/004; B27L 7/06

(57) ABSTRACT

A wood splitting turntable assembly includes a base that has an end plate slot therein for positioning around an end plate of a log splitter when the log splitter is positioned in a vertical orientation. The end plate slot has a width of at least 8.0 inches and a depth of at least 9.0 inches. A bearing is coupled to the base and a turntable is coupled to the bearing. A log can be positioned on the turntable when the base is positioned around the base of the log splitter. Moreover, the turntable is rotatable on the base to rotate the log for splitting the log around an entire circumference of the log without requiring a user to lift and reposition the log. An elastomeric band is positionable around the log to inhibit the log from falling apart from the log is split.

### (b) CROSS-REFERENCE TO RELATED APPLICATIONS

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to turntable devices and more particularly pertains to a new turntable device for rotating a log beneath a log splitter for splitting the log multiple times.

### (h) BRIEF SUMMARY OF THE INVENTION

An embodiment of the disclosure meets the needs presented above by generally comprising a base that has an end plate slot therein for positioning around an end plate of a log splitter when the log splitter is positioned in a vertical orientation. The end plate slot has a width of at least 8.0 inches and a depth of at least 9.0 inches. A bearing is coupled to the base and a turntable is coupled to the bearing. A log can be positioned on the turntable when the base is positioned around the base of the log splitter. Moreover, the turntable is rotatable on the base to rotate the log for splitting the log around an entire circumference of the log without requiring a user to lift and reposition the log. An elastomeric band is positionable around the log to inhibit the log from falling apart from the log is split.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a wood splitting turntable assembly according to an embodiment of the disclosure.

FIG. 2 is a top view of an embodiment of the disclosure.

FIG. 3 is a bottom view of an embodiment of the disclosure.

FIG. 4 is a right side view of an embodiment of the disclosure.

FIG. 5 is a front view of an embodiment of the disclosure.

FIG. 6 is a back view of an embodiment of the disclosure.

FIG. 7 is an exploded view of base, a bearing and a turntable of an embodiment of the disclosure.

FIG. 8 is a perspective view of an elastomeric band of an embodiment of the disclosure.

### (j) DETAILED DESCRIPTION OF THE INVENTION

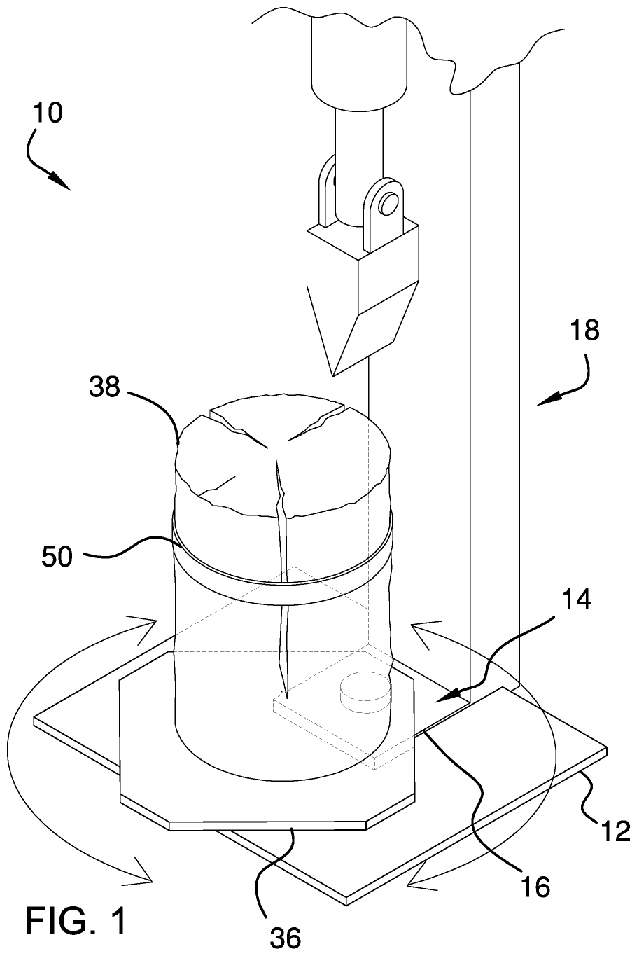

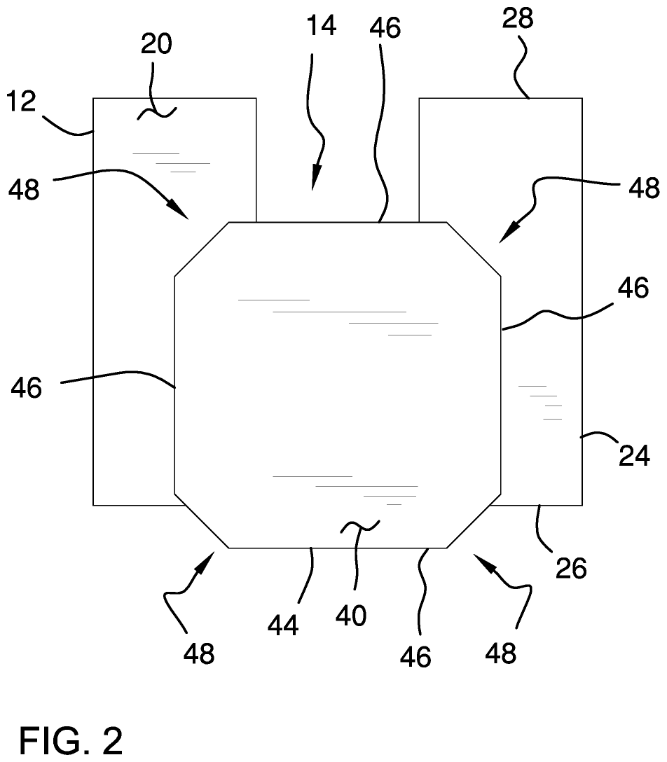

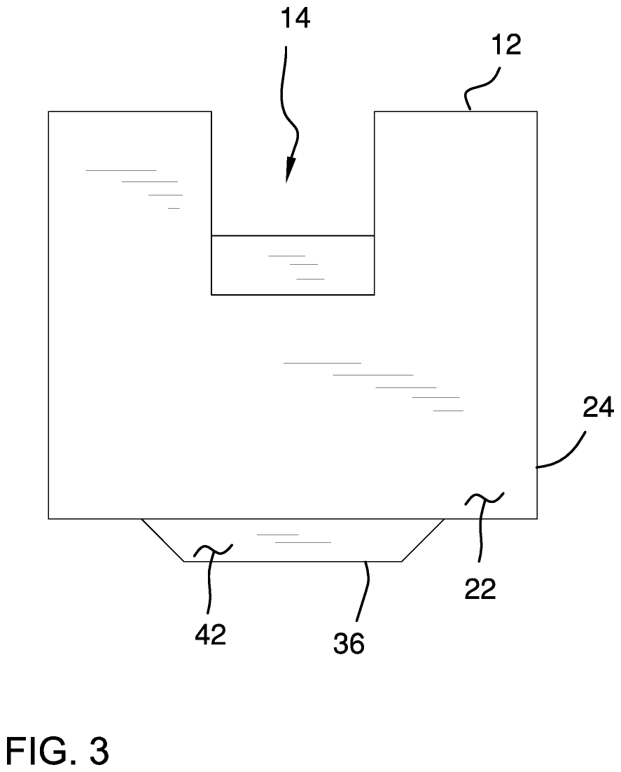

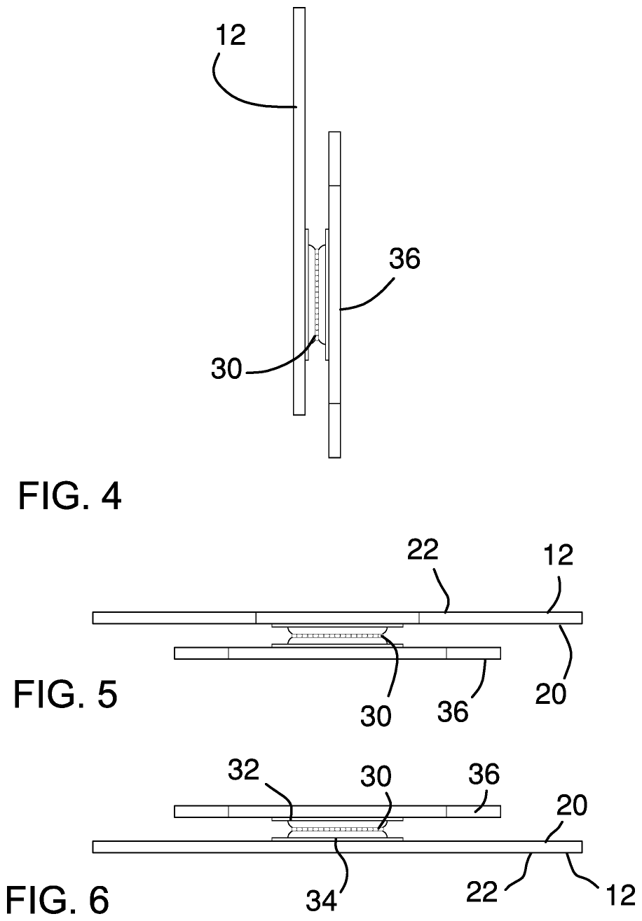

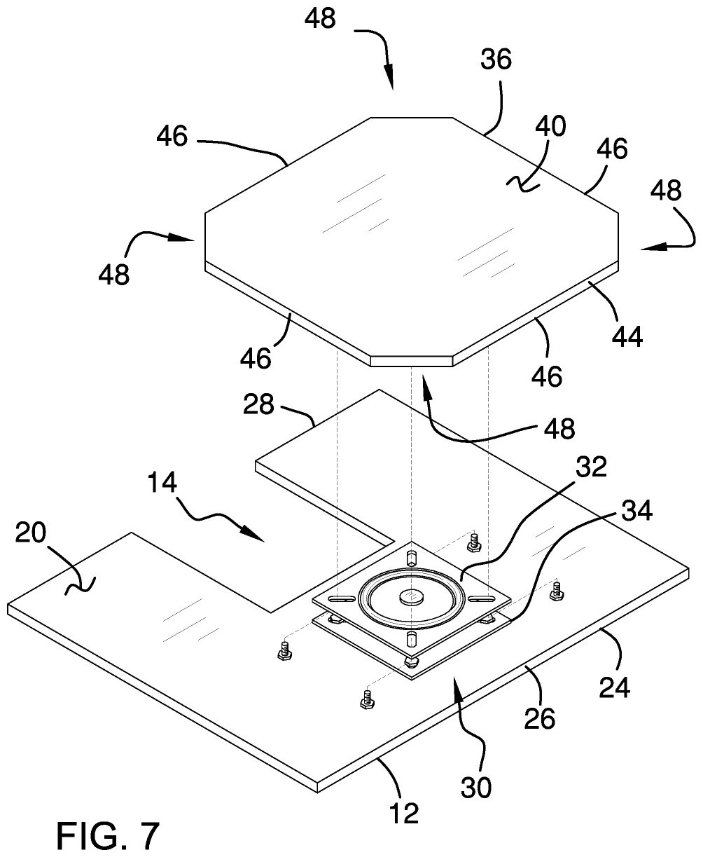

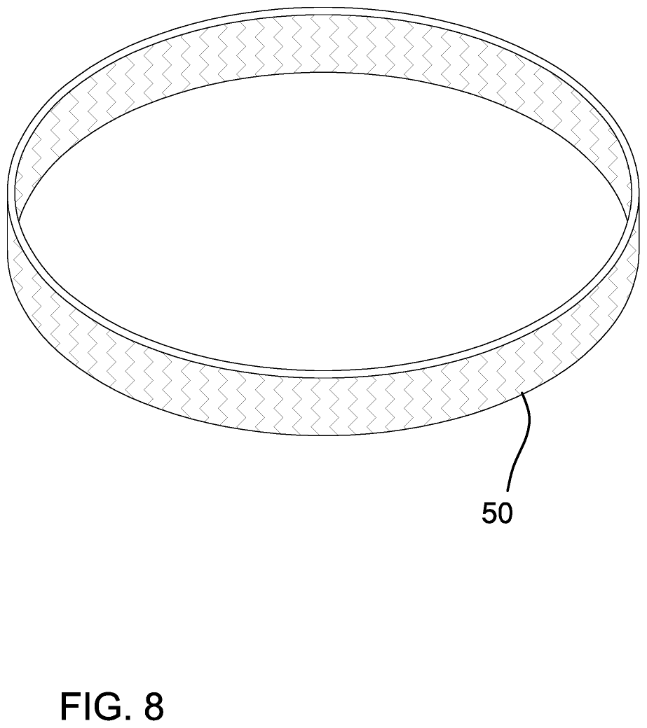

With reference now to the drawings, and in particular to FIGS. 1 through 8 thereof, a new turntable device embodying the principles and concepts of an embodiment of the disclosure and generally designated by the reference numeral 10 will be described.

As best illustrated in FIGS. 1 through 8, the wood splitting turntable assembly 10 generally comprises a base 12 that has an end plate slot 14 therein. The end plate slot 14 is positionable around an end plate 16 of a log splitter 18 when the log splitter 18 is positioned in a vertical orientation. The log splitter 18 may be a hydraulic log splitter or the like that includes a ram, a wedge and an end plate. The base 12 has a top surface 20, a bottom surface 22 and a peripheral edge 24 extending therebetween, and the bottom surface 22 lies on the ground when the base 12 is positioned around the log splitter 18.

The peripheral edge 24 has a front side 26 and a back side 28, the end plate slot 14 extends from the back side 28 toward the front side 26 and the end plate slot 14 is centrally positioned on the back side 28. Moreover, the end plate slot 14 has a width of at least 8.0 inches and a depth of at least 9.0 inches.

A bearing 30 is coupled to the base 12 and the bearing 30 is positioned on the top surface 20 of the base 12. The bearing 30 is rotatable about an axis extending through the top 20 and bottom 22 surfaces of the base 12. Additionally, the bearing 30 is positioned between the end plate slot 14 and the front side 26 of the perimeter edge of the base 12, the bearing 30 is centrally positioned with respect to the front side 26. The bearing 30 has a top portion 32 that is rotatably coupled to a lower portion 34, and the lower portion 34 is coupled to the base 12. The bearing 30 may be a ball bearing or other type of friction reducing bearing.

A turntable 36 is coupled to the bearing 30 and a log 38 can be positioned on the turntable 36 when the base 12 is positioned around the base 12 of the log splitter 18. The log may be a log with a diameter that is large enough to require the log to be split multiple times. The turntable 36 is rotatable on the base 12 to rotate the log 38 for splitting the log 38 around an entire circumference of the log 38. Thus, the log 38 can be split into a plurality of split pieces without requiring a user to lift and reposition the log 38. The turntable 36 has an upper surface 40, a lower surface 42 and an outer edge 44 extending therebetween. The lower surface 42 is coupled to the top portion 32 of the turntable 36 and the bearing 30 is centrally positioned on the lower surface 42.

The outer edge 44 has a plurality of intersecting sides 46 such that the turntable 36 has a square shape has four corners 48. Additionally, each of the corners 48 is chamfered to inhibit striking the log splitter 18 when the turntable 36 is rotated. The turntable 36 may have a diagonal width of approximately 24.0 inches. An elastomeric band 50 is positionable around the log 38 to inhibit the log 38 from falling apart when the log 38 is split. The elastomeric band 50 is continuous such that the elastomeric band 50 forms a closed loop and the elastomeric band 50 is comprised of a resiliently stretchable material for holding the log 38 together. The elastomeric band 50 is removable from the log 38 when the log 38 is finished is split to facilitate the split log to be stacked or otherwise stored.

In use, the base 12 is positioned on the ground such that the end plate 16 of the log splitter 18 is positioned in the end plate slot 14 in the base 12. The log 38 is positioned on the turntable 36 and the elastomeric band 50 is positioned around the log 38. The turntable 36 is rotated each time the log splitter 18 is actuated to split the log 38. Thus, the log 38 can be split around the entire circumference of the log 38 without requiring the user to lift or reposition the log 38. The elastomeric band 50 is removed from around the log 38 when the log 38 is finished being split. Thus, the resulting plurality of split logs can be stacked or otherwise stored.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wood splitting turntable assembly being configured to rotate a log on a splitter thereby facilitating the log to be split around a plurality of pieces without lifting the log, said assembly comprising:
a base having a end plate slot therein wherein said end plate slot is configured to be positioned around an end plate of a log splitter when the log splitter is positioned in a vertical orientation, said end plate slot having a width of at least 8.0 inches and a depth of at least 9.0 inches;
a bearing being coupled to said base;
a turntable being coupled to said bearing wherein said turntable is configured to have a log positioned thereon when said base is positioned around the base of the log splitter, said turntable being rotatable on said base wherein said turntable is configured to rotate the log for splitting the log around an entire circumference of the log without requiring a user to lift and reposition the log; and
an elastomeric band being positionable around the log wherein said elastomeric band is configured to inhibit the log from falling apart from the log is split, said elastomeric band being continuous such that said elastomeric band forms a closed loop, said elastomeric band being removable from the log when the log is finished being split wherein said elastomeric band is configured to facilitate the split log to be stacked or otherwise stored.

2. The assembly according to claim 1, wherein said base has a top surface, a bottom surface and a peripheral edge extending therebetween, said peripheral edge having a front side and a back side, said end plate slot extending from said back side toward said front side, said end plate slot being centrally positioned on said back side.

3. The assembly according to claim 2, wherein said bearing is positioned on said top surface, said bearing being rotatable about an axis extending through said top and bottom surfaces of said base, said bearing being positioned between said end plate slot and said front side of said perimeter edge of said base, said bearing being centrally positioned with respect to said front side, said bearing having a top portion being rotatably coupled to a lower portion, said lower portion being coupled to said base.

4. The assembly according to claim 3 wherein said turntable has an upper surface, a lower surface and an outer edge extending therebetween, said lower surface being coupled to said top portion of said turntable, said bearing being centrally positioned on said lower surface.

5. The assembly according to claim 3, wherein said turntable has an outer edge, said outer edge having a plurality of intersecting sides such that said turntable has a square shape having four corners, each of said corners being chamfered wherein said each of said corners is configured to inhibit striking the log splitter when said turntable is rotated.

6. A wood splitting turntable assembly being configured to rotate a log on a splitter thereby facilitating the log to be split around a plurality of pieces without lifting the log, said assembly comprising:
a base having a end plate slot therein wherein said end plate slot is configured to be positioned around an end plate of a log splitter when the log splitter is positioned in a vertical orientation, said base having a top surface, a bottom surface and a peripheral edge extending therebetween, said peripheral edge having a front side and a back side, said end plate slot extending from said back side toward said front side, said end plate slot being centrally positioned on said back side, said end plate slot having a width of at least 8.0 inches and a depth of at least 9.0 inches;
a bearing being coupled to said base, said bearing being positioned on said top surface, said bearing being rotatable about an axis extending through said top and bottom surfaces of said base, said bearing being positioned between said end plate slot and said front side of said perimeter edge of said base, said bearing being centrally positioned with respect to said front side, said bearing having a top portion being rotatably coupled to a lower portion, said lower portion being coupled to said base;
a turntable being coupled to said bearing wherein said turntable is configured to have a log positioned thereon when said base is positioned around the base of the log splitter, said turntable being rotatable on said base wherein said turntable is configured to rotate the log for splitting the log around an entire circumference of the log without requiring a user to lift and reposition the log, said turntable having an upper surface, a lower surface and an outer edge extending therebetween, said lower surface being coupled to said top portion of said turntable, said bearing being centrally positioned on said lower surface, said outer edge having a plurality of intersecting sides such that said turntable has a square shape having four corners, each of said corners being chamfered wherein said each of said corners is configured to inhibit striking the log splitter when said turntable is rotated; and
an elastomeric band being positionable around the log wherein said elastomeric band is configured to inhibit the log from falling apart from the log is split, said elastomeric band being continuous such that said elastomeric band forms a closed loop, said elastomeric band being removable from the log when the log is finished being split wherein said elastomeric band is configured to facilitate the split log to be stacked or otherwise stored.
